(19) United States
(12) Patent Application Publication
(10) Pub. No.: US 2025/0282061 A1
(43) Pub. Date: Sep. 11, 2025

(54) HANDLING DEVICE FOR HANDLING A PIECE GOOD AND A METHOD

(71) Applicant: Körber Supply Chain Logistics GmbH, Konstanz (DE)

(72) Inventors: Oliver Schulze, Überlingen (DE); Dirk-Udo Eisser, Reichenau (DE); Marco Fischer, Konstanz (DE); Rolf-Peter Skrdlant, Überlingen (DE); Richard Huber, Konstanz (DE)

(21) Appl. No.: 19/074,943

(22) Filed: Mar. 10, 2025

(30) Foreign Application Priority Data
Mar. 11, 2024 (DE) 10 2024 106 912.0

(51) Int. Cl. B25J 15/00; B25J 9/16

(52) U.S. Cl. CPC B25J 15/0066; B25J 9/1653; B25J 15/0033

(57) ABSTRACT

A handling device for picking up at least one piece good includes at least one gripping device configured to grip a piece good in a gripping position, wherein the gripping device has a contact surface with which the gripping device is in contact with the at least one gripped piece good during the gripping position, and wherein the gripping device is configured to vary the contact surface based on at least one piece good property of the at least one piece good to be gripped.

### BACKGROUND

The invention relates to a handling device for picking up at least one piece good and to a method.

Various devices are known from the prior art for picking up piece goods with different properties, for example parcels or postal items. Different properties include, for example, the weight, shape, dimensions, deformability, hardness, material, center of gravity, etc. of a piece good. These different properties may mean that not every piece good can be picked up by one and the same device or machine or can be handled in the same way by means of mechanical manipulation or a mechanical process.

In known sorting systems, several different devices are required to pick up piece goods of different sizes and/or weights. For example, smaller parcels can be picked up precisely with just one suction pad without inadvertently picking up neighboring parcels. However, larger, heavier packages cannot be lifted with just one suction pad, but require several or a larger suction pad. In a gripping device with several and/or larger suction pads, larger, heavier parcels can be picked up, but it is no longer possible to pick up a single parcel from the flow in a targeted manner when there are many, especially smaller, parcels lying next to each other. In a piece good stream or a parcel stream with different piece goods or parcels, only some of the piece goods or parcels can therefore be picked up or handled by such a device. It is possible to arrange a manual processing station, at which piece goods or parcels that cannot be processed are sorted out, in the direction of the flow of piece goods or parcels downstream of the device. However, this reduces the degree of automation and causes additional personnel costs. Alternatively, two or more devices with different numbers of suction pads can be connected in series. However, this increases the space requirement and leads to high installation, maintenance and operating costs.

It is therefore an object of the present invention to provide an improved handling device. In particular, it is an object of the present invention to provide a handling device which can handle a wide range of different piece goods easily and efficiently.

### SUMMARY

According to one aspect of the present invention, a handling device is provided for picking up at least one piece good. The handling device can comprise at least one gripping device, which is configured to grip a piece good in a gripping position. The gripping device can have a contact surface with which the gripping device is in contact with the at least one gripped piece good during the gripping position. The gripping device can be designed to vary the contact surface based on at least one property of the at least one piece good to be gripped.

Compared to the known prior art, the present invention has the advantage that a very wide range of piece goods, for example packages, with different piece good properties can be handled with just one handling device, for example a robot. The piece goods can be provided in a piece good stream. In this case, the present invention offers the advantage that by varying the contact surface, precisely the piece good to be gripped (hereinafter also referred to as the target piece good) can be handled without unintentionally influencing adjacent piece goods. This means that the handling device can also selectively pick out a target piece good from a large number of piece goods. As a result, the handling device can be used for a very wide range of applications.

The handling device can be a device that can move a piece good from a first position to a second position. In other words, the handling device can physically move a piece good. The handling device may be, for example, a robot with a movable arm. For example, the handling device may comprise a SCARA robot with four axes and four degrees of freedom. All axes can be designed as serial kinematics, i.e. the coordinate origin of the following axis is dependent on the position of the previous one. Due to its fast and repeatable movement, this type of robot is particularly suitable for so-called pick-and-place applications, in which a piece good can be moved from a first position to a second position. Alternatively, 5- or 6-axis robots are also possible. Other handling devices, for example handling devices guided on rollers or rails, are also conceivable. In other words, the handling device can be understood as any device that is configured to move a piece good. In particular, a movement can comprise a change of direction, an acceleration, a gripping process, a picking up, a holding, a releasing, a transportation and/or a displacement of a piece good. In particular, the term moving can also be understood to mean manipulation. An action can be performed that involves a translational and/or rotational movement of the piece good. In particular, this can be understood to mean physical manipulation of a piece good.

The handling device can comprise a gripper device. The gripper device can be designed to grip, hold and release a piece good. The gripping device can, for example, be a suction pad or comprise a suction pad. Alternatively or additionally, the gripping device can comprise a mechanical gripper, for example a pincer gripper. Other types of gripping devices are also possible. For example, the handling device can comprise a SCARA robot (Selective Compliance Assembly Robot Arm). Such a robot can also be referred to as a horizontal articulated arm robot

The handling device can be designed to pick up (e.g. grip) a piece good with piece good properties with the gripping device. The contact surface of the gripping device can be variable or changeable depending on the piece good properties to be gripped. In other words, the contact surface of the gripping device can be adaptable to the piece good to be gripped. In other words, the contact surface of the gripping device can be adapted for different piece goods or different groups of piece goods (e.g. with different piece good properties) depending on the piece good properties. The contact surface can be actively varied by the gripping device. In other words, the gripping device can have at least one element that can actively vary the contact surface. In addition, the contact surface can also change passively, for example if the gripping device has an elastic element that comes into contact with a piece good and deforms in the process. In a preferred embodiment of the present invention, such a passive variation of the contact surface is not meant by a variation of the contact surface based on piece good properties of the at least one piece good to be gripped.

The contact surface of the gripping device can be a surface that comes into contact with a gripped piece good. The contact surface can be the contact surface between the handling device and the piece good. The contact surface can be an integral surface or a contact surface composed of several sub-contact surfaces. In other words, the contact surface can comprise several individual surfaces that are separated from one another. The contact surface can have various contours. The contact surface can have a circular or polygonal contour. For example, the contact surface can be defined by a suction pad that is used as a gripping device. In this case, the contact surface can have a circular contour. In the case of a mechanical gripping device, such as tongs, the contact surface can be the sum of all contact surfaces between the gripping device and the piece good.

Piece good can be understood to mean a transportable good or object, in particular a parcel, small parcel, small envelope, etc. In particular, postal items or postal consignments can be understood as piece goods. Different piece goods can have different piece good properties. For example, the piece good property can be indicative of the nature of the piece good. The piece goods can be essentially symmetrical or asymmetrical in shape. Furthermore, the piece goods can each have different masses. For example, a piece good is a package made of a cardboard material, such as cardboard, with contents. A large number of configurations of the piece goods are conceivable, which is why there can also be a large number of different piece good properties. Furthermore, the piece good can be a package or packet made of a film material. The gripping position can be a position in which the gripping device is in physical contact with the piece good. The contact surface can be varied, for example, by increasing or decreasing it. A larger contact surface can transmit a greater force. For example, if the piece good is heavy, the contact surface can be increased so that the piece good can be held securely on the gripping device. In the case of a particularly small piece good (in terms of its dimensions), the contact surface can be reduced, for example, in order to lift the piece good out of a stream of piece goods without affecting other adjacent piece goods.

The handling device can, for example, be used in a system that is intended to transport and/or sort piece goods. For example, several piece goods can be moved on a conveyor belt in a stream of piece goods. It is also conceivable that the gripping device of the handling device comprises a gripper, in particular a vacuum suction pad, to handle piece goods. The handling device can be used, for example, to remove individual piece goods from a stream of piece goods.

Preferably, the gripping device is designed to vary the size and/or orientation of the contact surface in space based on at least one property of the at least one piece good to be gripped. The variation in the size of the contact surface can be realized, for example, by the gripping device adapting itself. In this case, a gripping element can be adapted so that the contact surface is increased. Additionally or alternatively, another gripping element of the gripping device can be used to form the contact surface. This makes it easy to vary the size of the contact surface. Furthermore, the gripping device can be designed to adapt the orientation of a gripped piece good in space. For this purpose, the gripping device can have at least one joint or movable section. This allows the gripping device to tilt or rotate the contact surface, for example. This makes it possible to grip and hold a piece good in such a way that a minimum force is exerted on the gripping device. In other words, it can be adapted to the center of gravity of the piece good. Furthermore, by rotating and/or swiveling the contact surface, it is possible to prevent a gripped piece good from colliding with other piece goods. Overall, this can improve the operation of the handling device and increase its efficiency. Furthermore, the contact surface can be adapted to a surface of the piece good before gripping it. This allows a safe gripping process to be realized. For example, it can happen that a piece good has an inclined surface on which the piece good is to be gripped. If the contact surface is tilted in line with the inclined surface before the piece good is actually gripped, the gripping process can be easier and faster. It should be noted here that the contact surface of the gripping device is also present when no piece good is being gripped. In this case, the contact surface is a theoretical contact surface between the gripping device and the piece good.

The gripping device can comprise at least one gripping element that is intended to be brought into contact with the piece good to be gripped in order to grip and/or hold the piece good. The size of the contact surface can be varied, for example, by additionally activating or deactivating several gripping elements of the gripping device. An activated gripping element is arranged or aligned in a position to interact with the piece good to be gripped. A deactivated gripping element is arranged or aligned in a position so as not to interact with a piece of goods. This means that the number of active gripping elements of the gripping device is increased or decreased. Alternatively or additionally, an active gripping element that is not suitable for a piece good with certain piece good properties can be replaced with another gripping element that is adapted to the piece good properties. It is also conceivable that the gripping device can be replaced with another gripping device. For example, a first gripping device for a first piece good and a second gripping device for a second piece good can be used alternately as required. In this case, the first gripping device and the second gripping device are part of the handling device or arranged on the handling device. The first gripping device has, for example, a smaller contact surface than the second gripping device. For example, the first gripping device has fewer and/or smaller gripping elements than the second gripping device. It is possible for a gripping element to be suitable for several piece goods with different piece good properties.

Preferably, the piece good property comprises a dimensioning of the piece good to be gripped, a surface quality of the piece good to be gripped, a weight of the piece good to be gripped, a center of mass of the piece good to be gripped and/or a placement of the piece good to be gripped relative to other piece goods. This allows the gripping device to grip the piece good to be gripped in such a way that the piece good can be handled without difficulty. In other words, the variable contact surface can be adapted to the piece good to be gripped. It is possible for the center of mass to be determined by means of the dimensions and weight of the piece good to be gripped. The center of gravity can be determined in conjunction with an optical analysis system or optical sensors. The dimensions of the piece good can be indicative of the dimensions of the piece good in space. The surface quality can be indicative of how a piece good is to be gripped. For example, a piece good with a film surface can have different gripping properties than a piece good with a cardboard surface. Depending on this, a different contact surface may be more suitable for one material than for the other. The weight of the piece good can be indicative of the mass of the piece good. The center of gravity can be indicative of a center of mass of the piece good. For example, the contents of the piece good may result in a center of mass that does not correspond to the geometric center of mass of the piece good. In such a case, considerable moments can occur during a gripping process, so that a variation of the contact surface can still ensure that the piece good is held securely. The placement of the piece good relative to other piece goods can indicate the position of the target piece good in a stream of piece goods. In other words, this information can be used to determine how well the target piece good can be gripped without affecting adjacent or neighboring piece goods.

Preferably, the handling device is designed to obtain or detect the at least one piece good property. For example, a piece good property can be detected by means of at least one sensor. Alternatively, a piece good property can be obtained from a database or from another handling device. The obtained or recorded piece good properties can be processed using a control unit. The control unit can be a computer-like device that is designed to receive information (input data), process the information and output information (output data). For example, the control unit can receive piece good information as input data and output handling commands to control the handling device (output data). In particular, the piece goods properties obtained or recorded can be used to adjust or set the contact surface of the gripping device. For example, a predefined contact surface can be stored in a database for a piece good property and/or a combination of different piece good properties of a piece good to be gripped, which can be retrieved by the control unit. The control unit can then control the handling device (e.g. the gripping device) in such a way that the contact surface is set (i.e. varied) according to the piece good piece good properties to be gripped.

Preferably, the handling device has a vision system to detect the at least one piece good property. In other words, the handling device can comprise at least one optical sensor, for example a camera, in order to determine the piece good properties to be gripped. Furthermore, a position of other piece goods can be detected in order to determine how the piece good to be gripped can be gripped. The at least one optical sensor can be integral with the handling device or can be arranged on the handling device. Alternatively or additionally, the handling device can be connected to at least one optical sensor. The at least one sensor can be designed to provide information for controlling the handling device. This means that a sensor already provided on the handling device can be used to obtain the piece good properties.

Preferably, the handling device is designed to determine the contact surface individually for each piece good. In other words, the contact surface of the gripping device can be adapted for any number of piece goods to be handled in succession. For example, the contact surface can be smaller for a first piece good than for a second piece good that is, for example, heavier than the first piece good. The piece good property of the second piece good can, for example, be transmitted to the control unit of the handling device or retrieved by the control unit of the handling device. The contact surface of the gripping device can then be adapted to the second piece good. This process can be repeated as often as required for any number of piece goods with different piece good properties.

Preferably, the handling device is designed to move at least one piece good to a different position. In particular, the handling device can be designed to move the piece good to be gripped from a first position to a second position. For this purpose, the handling device picks up the at least one piece good at the gripping position with the gripping device, so that the at least one piece good is held in the gripping device. The handling device can then transfer the at least one piece good from the gripping position to an end position. In the end position, the gripping device can release or place the piece good.

Preferably, the handling device has a parallelogram guide to displace the gripping device in space. The parallelogram guide can be understood as a mechanism with which a piece good held on a double arm is held at the original angle in the plane perpendicular to the axis of rotation during a movement of the gripping device. This can be used to achieve a uniform displacement of the piece good. This is particularly advantageous for fragile piece goods.

Preferably, the handling device is designed to rotate the gripping device. This makes it possible to move the at least one piece good along a circular path. In other words, the at least one piece good can be moved around an axis of rotation in this way. This makes it possible to align the piece good when it is held by the gripping device, for example in order to be able to hold and/or place the piece good better.

Preferably, the handling device has a linear drive to move the gripping device in space. The linear drive can preferably be an electric linear drive. The linear drive is particularly suitable for moving the at least one piece good in a straight line or along an axis. For example, the linear drive can be used to move the gripping device in the direction of the piece good in order to grip the piece good. After gripping the piece good with the gripping device, the piece good can then be lifted by the linear drive in order to move or displace the piece good from the gripping position to the end position.

Preferably, the handling device has at least one conveyor that is designed to bring piece goods into a gripping area of the gripping device. The conveyor can convey piece goods in a conveying direction. The conveyor can comprise a conveyor belt or conveyor rollers. When a piece good reaches a gripping position, the handling device can handle the piece good from the conveyor using the gripping device. The conveyor can comprise one or more rows of rollers. The rows of rollers can, for example, feed piece goods onto a conveyor belt or divide them into different piece good streams. It is therefore advantageous to arrange the rows of rollers in the operating direction after a singulator. More specifically, the rows of rollers are advantageously used to divide a flow of piece goods after the singulator. The conveyor can comprise a belt conveyor. Belt conveyors are advantageous for transporting large volume flows of piece goods. For example, belt conveyors in the system must be designed in such a way that they can handle a wide variety of transport loads while maintaining high availability and reliability. Belt conveyors can precisely position and sort piece goods with high frequency and short acceleration and braking distances. Alternatively or additionally, the conveyor can include a chute on which the piece goods are transported to the gripping position.

Preferably, the gripping device has at least one gripping element, preferably a plurality of gripping elements. The at least one gripping element can be a suction pad. The suction pad can have a suction cup. The at least one gripping element can have the variable contact surface of the gripping device. In other words, the gripping elements define the variable contact surface. This means that the variable contact surface can be part of the gripping element. In the case of a mechanical tong gripper, for example, tongs can correspond to the gripping elements.

Preferably, the gripping elements can be moved relative to each other. This means that the gripping elements are designed to be movable relative to one another. In other words, a plurality of gripping elements can be provided on the gripping device (i.e. more than one gripping element). The gripping elements can be movable relative to each other. For example, the gripping elements are arranged to move towards and away from each other. The gripping elements can be displaced relative to one another by a pivoting movement and/or by a linear or rectilinear movement. The gripping elements can have reset elements that apply a force to the gripping elements in order to transfer the gripping elements from a closed position to an open position

Preferably, the gripping device has at least one connecting element to which at least one gripping element is attached or can be attached, wherein the at least one gripping element defines the contact surface. In other words, the connecting element forms an interface between the gripping device and the gripping elements. The connecting element preferably has a connection geometry that corresponds to a further connection geometry of the gripping element. For example, the connecting element and the gripping element can comprise a plug-in connection and/or screw connection. The connecting element can preferably be designed in such a way that the connecting element can be connected to several different gripping elements. In other words, the connecting element is preferably compatible with several gripping elements, which in particular have different contact surfaces.

Preferably, the at least one connecting element is designed in such a way that a vacuum can be passed on to a gripping element connected to it. For this purpose, the connecting element can comprise a through opening or a valve. In particular, the connecting element can be detachably connected to the at least one gripping element in a fluid-tight, in particular air-tight, manner. For this purpose, the gripping element is preferably designed as a suction pad or suction cup. Such a connecting element is particularly advantageous in order to be used with a suction pad or to be arranged on a suction pad.

Preferably, the gripping device is designed to grip at least two piece goods simultaneously in the gripping position. For example, the gripping device can have several gripping elements that are designed to pick up or grip at least two piece goods at the same time. For this purpose, the piece goods can already be arranged in the gripping position corresponding to the gripping elements of the gripping device. In particular, the gripping positions of the at least two piece goods can be predetermined so that the at least two piece goods can be picked up simultaneously by the handling device, in particular the gripping device. It is conceivable that the handling device comprises two gripping devices in order to grip two piece goods simultaneously or in quick succession.

Preferably, the contact surface is defined exclusively by a single gripping element or the contact surface is defined by several gripping elements. The gripping device can therefore comprise a single gripping element or several gripping elements. The total contact surface of the gripping device is made up of the sum of the contact surfaces of the individual gripping elements. For example, the gripping device can comprise a suction pad with a single gripping element. The contact area of the suction pad essentially corresponds to a suction area or a surface of the suction cup. Alternatively, the gripping element can have several gripping elements that are arranged next to each other or adjacent to each other. A larger contact surface, in particular a larger suction surface, makes it possible to grip and handle heavy piece goods.

Preferably, the gripping elements are designed differently, in particular the gripping elements have a different geometry. It is possible for the gripping elements to have different sizes. As a result, the contact surface of the gripping device can be adapted more precisely depending on the piece good properties. For example, several smaller gripping elements or a single larger gripping element can be activated in this way. This allows the gripping device to be adapted to the weight and size of the piece good to be gripped.

Preferably, the at least one gripping element can be reversibly attached to the at least one connecting element. In other words, the gripping element can be detachably connectable to the connecting element. In particular, the gripping element can be connected to the connecting element in a force-fit and/or form-fit manner. The connecting element and the at least one gripping element can both be designed in such a way that a non-positive and/or positive connection between the connecting element and the at least one gripping element is possible. For example, the gripping elements and the connecting elements can be detachably connected to each other by means of a snap-in connection, a bayonet connection and/or a screw connection.

Preferably, the gripping device has a magazine in which a large number of gripping elements are provided, wherein the gripping device is designed in such a way that different gripping elements can be mounted on it. The gripping device can be designed to accommodate different gripping elements in order to handle piece goods. In this way, the appropriate gripping element for a specific piece good to be gripped can be selected and attached to the gripping device depending on the piece good properties. The gripping elements can thus be interchangeably mounted on the gripping device. The gripping elements are preferably mounted automatically.

Preferably, the magazine is designed as a turret mechanism. This means that the gripping elements, preferably different gripping elements, are arranged on a circular line and can be rotated around a common axis of rotation. By rotating the gripping elements around the axis of rotation, one or more gripping elements of the gripping device can be replaced. The turret mechanism can be used, for example, to couple or connect the individual gripping elements to the connecting element

Preferably, the gripping device has a changing mechanism in which, depending on the position of the changing mechanism, a gripping element is positioned in such a way that it can come into contact with a piece good to be gripped. In other words, the changing mechanism can be part of the gripping device. The gripping element of the gripping device can be exchanged by the changing mechanism depending on the piece good properties to be gripped. The changing mechanism can select from several different gripping elements and bring them into a position in order to grip a piece to be gripped. For example, the changing mechanism can comprise a rotary or turret mechanism on which several gripping elements with different contact surfaces are arranged along a circumferential direction. By rotating the changing mechanism about an axis of rotation, a desired gripping element can be brought into a position to grip a piece to be gripped. In particular, the angle of the gripping element can be adjusted by rotating the changing mechanism.

Preferably, a changing device can be arranged separately from the handling device. The changing device can comprise several gripping elements. The changing device can be designed as a magazine or comprise a magazine from which the handling device automatically selects the desired gripping element and arranges or mounts it on the gripping device. Alternatively, the changing device can comprise a turret mechanism which brings the gripping element to be connected to the handling device into position by rotating it about an axis of rotation.

Preferably, the gripping device has a folding mechanism, whereby the number of gripping elements arranged in the gripping position can be changed. For example, a swivel movement can be used to provide additional gripping elements for picking up a piece good to be gripped or to bring them into position. The folding mechanism can, for example, be arranged adjacent to the gripping elements of the gripping device, wherein the folding mechanism comprises further gripping elements. The folding mechanism can, for example, be moved from a first position to a second position. In the first position of the folding mechanism, the other gripping elements are deactivated. This means that in the first position, the further gripping elements are not intended to grip or manipulate a piece good. In the second position, the other gripping elements are activated. This means that the gripping elements and the other gripping elements are intended to grip or manipulate a piece good. Alternatively or additionally, the gripping elements can also be arranged on a further folding mechanism, by means of which the gripping elements can be moved from a first position to a second position.

Preferably, the gripping device is designed to grip at least one piece good with a suction pad and/or a mechanical gripper. The mechanical gripper can, for example, comprise a pincer gripper. The suction pad is suitable for gripping various piece goods with different properties such as size, shape, weight, surface quality, etc. and moving them from a starting position to an end position. The suction pad is preferably arranged downstream of the singulator in the operating direction. Gripping can be carried out using a vacuum. The pressure difference is created by forming a vacuum between the suction pad and the piece good. More precisely, as soon as the suction pad touches the surface of the piece good and the surface is sealed off from the environment, a vacuum is created. The holding force depends on the pressure difference between the ambient pressure and the pressure in the suction pad and on the size of the contact surface between the vacuum suction pad and the piece good. A suitable gripping element can therefore be selected depending on at least one piece good property. A gripping point or suction point can be specified as a further piece good property depending on the shape of the piece good.

Preferably, the handling device has at least one further gripping device with at least one further gripping element, which can be activated depending on the piece good properties to be gripped in order to increase the contact surface. Alternatively, the additional gripping device can be used to handle additional piece goods. For example, the handling device can comprise a vacuum suction pad and a pincer gripper, wherein the vacuum suction pad and the pincer gripper are each intended for piece goods with different piece good properties.

According to a further aspect of the present invention, there is provided a method of picking up at least one piece good. The method may comprise: gripping at least one piece good in a gripping position using a gripping device having a contact surface with which the gripping device is in contact with the at least one piece good to be gripped during the gripping position, wherein the contact surface is adapted based on at least one piece good property of the at least one piece good to be gripped. The piece goods can be released one after the other. Alternatively, at least two piece goods can be picked up with a small intermediate movement.

In other words, the method for handling at least one piece good with a handling device according to any one of the preceding claims may comprise the steps of: detecting or obtaining at least one piece good property of a piece good to be gripped; adapting a contact surface of a gripping device of the handling device based on the piece good property; gripping and handling the piece good with the gripping device.

The suction device is equipped with several suction pads, for example, which can be moved in relation to each other depending on the piece good to be gripped. For example, a suction pad could be fixed to the robot arm pick smaller piece goods. Other suction pads can be folded down by a swivel mechanism, for example, to grip piece goods with different piece good properties, such as larger and/or heavier piece goods. Alternatively, the gripping device can have an interchangeable gripper or a changing device that selects the appropriate suction pad from an adjacent changing station. A turret mechanism is also possible, which is mounted on a robot arm of the handling device, for example, and rotates down the appropriate number of suction pads. Instead of different numbers of suction pads, it is also possible to change only the size or geometry of the suction pad used or to replace the suction pad with a different gripping mechanism, for example a pincer gripper.

A further aspect of the present invention relates to the use of a handling device according to one of the above embodiments in a sorting system.

The gripping device can comprise a physical mechanism, in particular a movable gripper. The gripping device can be designed to move linearly, for example by means of a parallelogram guide. The gripping device can also a pivot point, for example at the rear end of the gripper, which can be pivoted through 180°. The gripping device can be controlled as a function of a vision system. An individual gripper can thus be specifically selected, controlled and/or moved depending on the center of gravity, geometry, material properties, weight, for example, detected by a scale. The individual gripper can approach during the transportation of the piece good as soon as a risk of loss has been detected, for example by leakage detection, weight deviation or vision information. If at least two suitably positioned piece goods, for example smaller piece goods, are detected by the vision system, at least one further gripper can be lowered in order to pick up both piece goods with one movement and transport them together.

Individual features of the embodiments shown can also be used in other embodiments, unless this is expressly excluded. Further developments and advantages mentioned in connection with the device also apply analogously to the method and vice versa.

### BRIEF DESCRIPTION OF THE DRAWINGS

Further advantages and features of the present invention are apparent from the following description with reference to the figures given.

FIG. 1 is a schematic view of an embodiment of a handling device according to the invention;

FIG. 2 is a schematic view of an embodiment of a handling device according to the invention; and

FIG. 3 is a schematic view of a method for using a handling device.

### DETAILED DESCRIPTION OF THE PREFERRED EMBODIMENTS

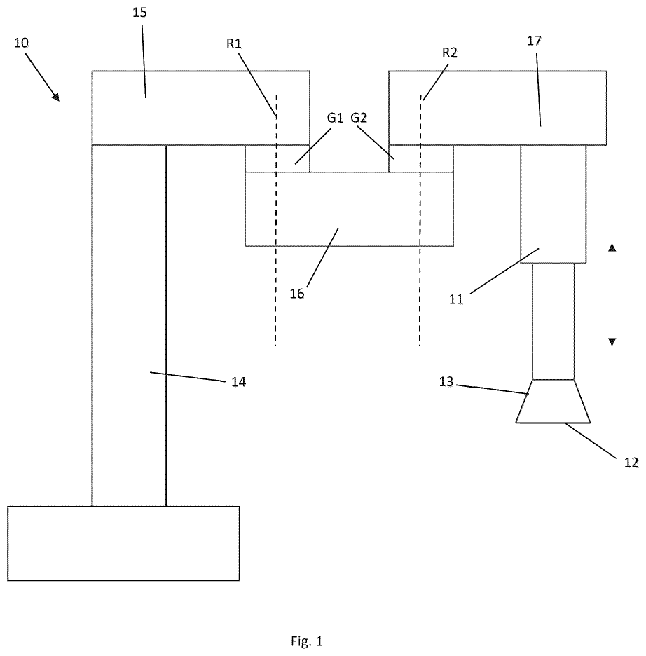

FIG. 1 shows a schematic view of a handling device 10. The handling device 10 has a support element 14 and several swivel elements. The support element 14 is immovable or fixed. A first swivel element 15 is arranged at an axial end of the support element 14 or in the area of an axial end of the support element 14.

The handling device 10 has a first rotation joint G1 and a second rotation joint G2. The first rotation joint G1 is arranged at an axial end or in the region of an axial end of the first swivel element 15. A second swivel element 16 is arranged between the first rotation joint G1 and the second rotation joint G2. The second swivel element 16 is pivotably connected to the first swivel element 15 about a first axis of rotation R1 of the rotation joint R1.

The second rotation joint G2 is arranged at the axial end of the second swivel element 16 facing away from the first swivel element 15 or is arranged in the area of the axial end of the second swivel element 16 facing away from the first swivel element 15. The second swivel element 16 is connected to a third swivel element 17 via the second rotation joint G2. The third swivel element 17 is connected to the second swivel element 10 so that it can swivel about a second axis of rotation R2 of the second rotation joint G2.

The support element 14 extends essentially parallel to the first axis of rotation R1 and/or to the second axis of rotation R2. The first swivel element 15 extends essentially in a direction perpendicular to the first axis of rotation R1 and/or to the second axis of rotation R2.

A gripping device 11 is arranged in the area of the new end of the third swivel element 17. The present gripping device 11 comprises a gripping element 13. The gripping device 11 is designed as a vacuum suction pad. The gripping element 13 is designed as a suction element, in particular as a suction cup. Alternatively, other types of gripping devices 11, for example a mechanical pincer gripper, are conceivable. The handling device 10 can also have more than one gripping device 11. A combination of different types of gripping devices 11 is also possible. For example, the handling device 10 can comprise a vacuum suction pad and a mechanical pincer gripper, which are activated or deactivated or exchanged by a mechanism as required depending on the piece good properties to be gripped.

The gripping device 11 can be moved linearly in a vertical direction. The direction of movement of the gripping device 11 is shown schematically by the double arrow. This allows the gripping element 13 to be brought into contact with a piece good to be gripped. For example, the gripping device 11 can comprise a linear motor or a linear actuator for this purpose. It is also possible for the linear movement of the gripping device 11 to be activated hydraulically or pneumatically. The vertical direction is essentially a direction parallel to the support element 14. In operation, the vertical direction can preferably run parallel to the direction of gravity.

The gripping element 13 has a contact surface 12. The contact surface 12 of the gripping element 13, which is designed as a suction element, is circular or has a circular or annular geometry. Alternatively, other geometries of the contact surface 12, for example polygonal geometries, are conceivable. The gripping element can alternatively or additionally comprise a pincer element.

The gripping element 13 has a variable design. More precisely, the contact surface 12 of the gripping element 13 is variable. The contact surface 12 of the gripping element 13 is adapted depending on at least one piece good property of the piece good to be gripped. The contact surface 12 can be adapted, for example, by exchanging the gripping element 13. The handling device 10 can have a magazine in which several different gripping elements 13 are arranged. If required, a suitable gripping element 13 can be selected from the magazine depending on the piece good properties to be gripped and arranged or mounted on the gripping device 11. The selection and assembly can be carried out automatically by a robot arm. The magazine 10 can be stationary. Alternatively or additionally, the magazine can comprise a turret mechanism. This allows the gripping elements of the gripping device 11 to be brought into position and/or changed by rotating them about an axis of rotation.

The gripping device 11 has a connecting element for this purpose. The connecting element is used to attach the gripping elements 13 to the gripping device 11. The connecting element is preferably designed in such a way that the gripping elements 13 can be detachably connected to the gripping device. The connecting element can provide a detachable positive connection and/or a detachable non-positive connection for the gripping elements 13.

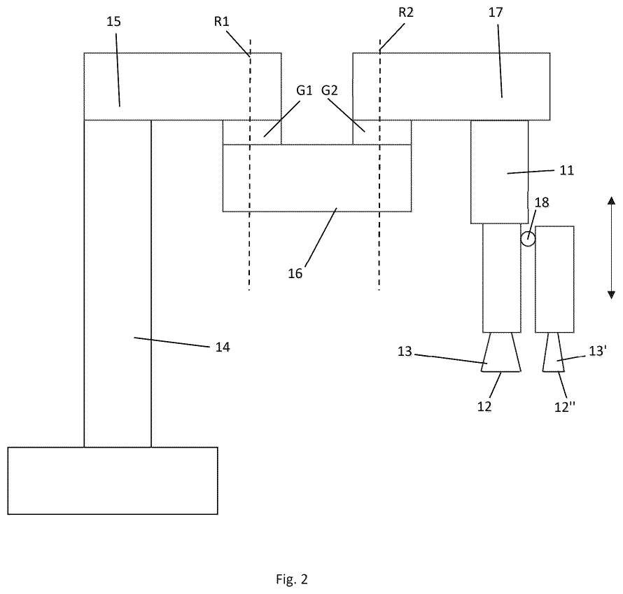

FIG. 2 shows a further embodiment of handling device 10. The handling device 10 shown essentially corresponds to the handling device 10 shown in FIG. 1. The handling device 10 shown in FIG. 2 differs in that the gripping device 11 has a folding mechanism 18.

A further gripping element 13′ is arranged on the folding mechanism 18. The further gripping element 13′, which is arranged on the folding mechanism 18, has a smaller further contact surface 12′ than the gripping element 13. The further gripping element 13′ can be moved into a first position and into a second position by folding it. In the first position, the further gripping device 13′ is deactivated. This means that the further gripping device 13′ cannot come into contact with any piece goods and grip the piece good. In the second position, the further gripping device 13′ is arranged in such a way that it can grip a piece good together with the gripping device 13. In the second position, the total effective contact surface is formed by the sum of the contact surface 12 of the gripping element 13 and the further contact surface 12′ of the further gripping element 13′. If necessary, the further gripping element 13′ can be returned to the first position by folding it back.

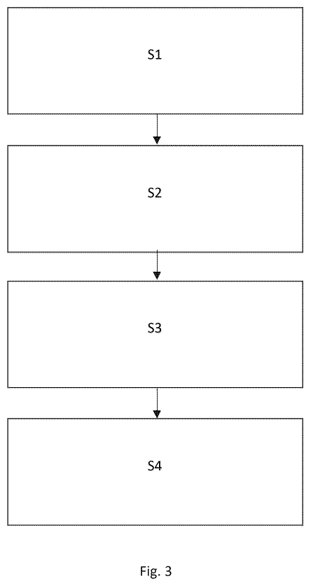

FIG. 3 shows a schematic flow diagram of a method for picking up at least one piece good with a handling device 10.

The method comprises gripping at least one piece good in a gripping position using a gripping device 11 having a contact surface 12 with which the gripping device 11 is in contact with the at least one gripped piece good during the gripping position, wherein the contact surface 12 is adapted based on at least one piece good property of the at least one piece good to be gripped.

A first step S1 comprises detecting or obtaining at least one piece good property of a piece good to be gripped. In other words, the piece good properties can be retrieved from a database or detected by means of sensors

A second step S2 comprises adapting the contact surface 12 of the gripping device 11 of the handling device 10 based on the piece goods information detected or obtained. For example, the contact surface 12 can be extended for a piece good with a greater weight in relation to an immediately preceding piece good. This can be done by changing the gripping element 13 or by adding at least one further gripping element 13.

A third step involves gripping and handling the piece goods with the gripping device 11. This means that the piece goods are moved by the handling device 10. For example, the piece goods can be sorted out of a consignment stream. The piece goods can be transferred from a first conveyor belt to a second conveyor belt.

Other embodiments of the present invention are possible and can be understood and carried out by persons skilled in the art when using the claimed subject matter from studying the figures, the disclosure and the appended claims. In particular, the respective parts/functions of the respective embodiment described above can also be combined with each other. Further, various steps of the method may be performed in a different order than disclosed herein. In the claims, the word “comprising” does not exclude other elements or steps and the indefinite piece good “one” or “a” does not exclude a plurality. The mere fact that certain measures are recited in interdependent claims does not mean that a combination of these measures cannot be advantageous. Any reference signs in the claims should not be construed as limiting the scope of the claims.

### LIST OF REFERENCE SIGNS

G1 First rotation joint
G2 Second rotation joint
R1 First axis of rotation
R2 Second axis of rotation
10 Handling device
11 Gripping device
12 Contact surface
12′ Further contact surface
13 Gripping element
13′ Additional gripping element
14 Support element
15 First swivel element
16 Second swivel element
17 Third swivel element
18 Folding mechanism

The invention claimed is:

1. A handling device for picking up at least one piece good, comprising:
at least one gripping device configured to grip a piece good in a gripping position;
wherein the gripping device has a contact surface with which the gripping device contacts the at least one gripped piece good during the gripping position; and
wherein the gripping device is configured to vary the contact surface based on at least one piece good property of the at least one piece good to be gripped.

2. The handling device according to claim 1, wherein the gripping device is configured to vary the size and/or orientation of the contact surface in space based on the at least one piece good property of the at least one piece good to be gripped.

3. The handling device according to claim 2, wherein the at least one piece good property comprises a dimensioning of the at least one piece good, a surface condition of the at least one piece good, a weight of the at least one piece good, a center of mass of the at least one piece good and/or a placement of the at least one piece good relative to other piece goods.

4. The handling device according to claim 3, further comprising:
a vision system to detect the at least one piece good property.

5. The handling device according to claim 4, wherein the gripping device comprises at least one gripping element.

6. The handling device according to claim 5, wherein the at least one gripping element includes a plurality of gripping elements.

7. The handling device according to claim 6, wherein at least two gripping elements of the plurality of gripping elements are configured differently from one another.

8. The handling device according to claim 7, wherein the at least two gripping elements are configured to have a different geometry from one another.

9. The handling device according to claim 6, wherein the gripping device has a magazine in which the plurality of gripping elements is provided, wherein the gripping device is configured such that different gripping elements of the plurality of gripping elements that are configured differently from one another can be mounted thereon.

10. The handling device according to claim 7, wherein the at least two gripping elements are differently shaped from one another.

11. The handling device according to claim 10, wherein the at least two gripping elements have a different geometry from one another.

12. The handling device according to claim 11, wherein the gripping device comprises a changing mechanism in which, depending on the position of the changing mechanism, the at least one gripping element is positioned such that it can come into contact with the at least one piece good to be gripped.

13. The handling device according to claim 12, wherein the gripping device is configured to grip at least two piece goods of the at least one piece good simultaneously in the gripping position.

14. The handling device according to claim 1, wherein the at least one piece good property comprises a dimensioning of the at least one piece good, a surface condition of the at least one piece good, a weight of the at least one piece good, a center of mass of the at least one piece good and/or a placement of the at least one piece good relative to other piece goods.

15. The handling device according to claim 1, further comprising:
a vision system to detect the at least one piece good property.

16. The handling device according to claim 1, wherein the gripping device comprises at least one gripping element.

17. The handling device according to claim 16, wherein the at least one gripping element includes a plurality of gripping elements.

18. The handling device according to claim 17, wherein at least two gripping elements of the plurality of gripping elements are configured differently from one another.

19. The handling device according to claim 1, wherein the gripping device is configured to grip at least two piece goods of the at least one piece good simultaneously in the gripping position.

20. A method for picking up at least one piece good, comprising:
gripping at least one piece good in a gripping position using a gripping device with a contact surface with which the gripping device is in contact with the at least one piece good during the gripping position; and
wherein the contact surface is adapted based on at least one piece good property of the at least one piece good to be gripped.
